(19) United States
(12) Patent Application Publication
(10) Pub. No.: US 2025/0341223 A1
(43) Pub. Date: Nov. 6, 2025

(54) ELECTROHYDROSTATIC ACTUATOR WITH INTEGRATED PUMP

(71) Applicant: Oshkosh Corporation, Oshkosh, WI (US)

(72) Inventors: Erik Ellifson, Oshkosh, WI (US); Patrick Dillman, Hartford, WI (US); Matt Berg, Oshkosh, WI (US); Martin Schimke, Red Granite, WI (US); Chris Rukas, Oshkosh, WI (US); Land Barnum, Oshkosh, WI (US); Bill Parkin, Oshkosh, WI (US)

(73) Assignee: Oshkosh Corporation, Oshkosh, WI (US)

(21) Appl. No.: 19/196,309

(22) Filed: May 1, 2025

Related U.S. Application Data
(60) Provisional application No. 63/641,925, filed on May 2, 2024.

(51) Int. Cl. F15B 1/033; F15B 15/18

(52) U.S. Cl. CPC F15B 1/033; F15B 15/18; F15B 2211/20515; F15B 2211/212

(57) ABSTRACT

An actuator includes a cylinder, a piston slidably received within the cylinder, a rod coupled to the piston and at least partially extending outwardly from the cylinder, a base coupled to the cylinder, a pump at least partially received within the base and including an inlet port, an electric motor configured to drive the pump and at least partially received within the base, an accumulator including an accumulator cylinder that is enclosed within the cylinder and an accumulator piston slidably received within the accumulator cylinder, and an accumulator valve enclosed within the cylinder. The accumulator valve is configured to selectively provide fluid communication between the accumulator and the inlet port.

### CROSS-REFERENCE TO RELATED PATENT APPLICATIONS

This application claims the benefit of and priority to U.S. Provisional Patent Application No. 63/641,925, filed on May 2, 2024, which is incorporated herein by reference in its entirety.

### BACKGROUND

Hydraulic actuators typically include a piston that is slidably arranged within a cylinder, and the piston is configured to selectively extend or retract relative to the cylinder.

### SUMMARY

In some aspects, the present disclosure relates to an actuator including: a cylinder; a piston slidably received within the cylinder; a rod coupled to the piston and at least partially extending outwardly from the cylinder; a base coupled to the cylinder; a pump at least partially received within the base and including an inlet port; an electric motor configured to drive the pump and at least partially received within the base; an accumulator including an accumulator cylinder that is enclosed within the cylinder and an accumulator piston slidably received within the accumulator cylinder; and an accumulator valve enclosed within the cylinder, wherein the accumulator valve is configured to selectively provide fluid communication between the accumulator and the inlet port.

In some aspects, the present disclosure relates to an actuator including: a cylinder; a piston slidably received within the cylinder, wherein the piston divides a portion of an internal volume of the cylinder into a piston chamber and a rod chamber; a rod coupled to the piston and at least partially extending outwardly from the cylinder; a base coupled to the cylinder; a pump at least partially received within the base and including a first port and a second port; an electric motor configured to drive the pump and enclosed within the cylinder; an accumulator enclosed within the cylinder; and an accumulator valve enclosed within the cylinder, wherein the pump is configured to operate in a first configuration and a second configuration, in the first configuration, the pump is configured to supply pressurized fluid to the piston chamber so that the rod extends from the cylinder, and in the second configuration, the pump is configured to supply pressurized fluid to the rod chamber so that the rod retracts into the cylinder, wherein when the pump is in the first configuration and the second configuration, the accumulator valve is configured to selectively provide fluid communication between the accumulator and whichever of the first port and the second port is at a lower pressure.

In some aspects, the present disclosure relates to an actuator including: an outer body; a piston slidably received within the outer body; a rod coupled to the piston and at least partially extending outwardly from the outer body; a base coupled to a first end of the outer body, wherein the rod extends outwardly from a second end of the outer body; a pump at least partially received within the base; an electric motor configured to drive the pump and at least partially received within the base; an accumulator including an accumulator cylinder and an accumulator piston slidably received within the accumulator cylinder; and an accumulator valve arranged axially between the pump and the accumulator, wherein each of the piston, the rod, the base, the pump, the electric motor, the accumulator, and the accumulator valve is coupled to or housed within the outer body, and wherein the pump, the accumulator, and the accumulator valve operate in a closed fluid circuit.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a partial cross-sectional view of an electrohydrostatic actuator, according to an exemplary embodiment;

FIG. 2 is a partially exploded view of the electrohydrostatic actuator of FIG. 1 with an accumulator cylinder hidden, according to an exemplary embodiment;

FIG. 3A is a perspective view of a pump of the electrohydrostatic actuator of FIG. 1, according to an exemplary embodiment;

FIG. 3B is a perspective view of a pump and motor of the electrohydrostatic actuator of FIG. 1, according to an exemplary embodiment;

FIG. 4 is an exploded view of a pump and motor of the electrohydrostatic actuator of FIG. 1, according to an exemplary embodiment;

FIG. 5 is a cross-sectional view of an accumulator valve plate of the electrohydrostatic actuator of FIG. 1, according to an exemplary embodiment;

FIG. 6 is a cross-sectional view of a rod passageway of the electrohydrostatic actuator of FIG. 1, according to an exemplary embodiment;

FIG. 7 is a cross-sectional view of a piston passageway of the electrohydrostatic actuator of FIG. 1, according to an exemplary embodiment;

FIG. 8 is a cross-sectional view of an accumulator passageway of the electrohydrostatic actuator of FIG. 1, according to an exemplary embodiment;

FIG. 9 is a cross-sectional view of a charge chamber and a charge port of the electrohydrostatic actuator of FIG. 1, according to an exemplary embodiment;

FIG. 10 is a schematic illustration of a fluid circuit of the electrohydrostatic actuator of FIG. 1, according to an exemplary embodiment; and

FIG. 11 is a perspective view of a charge valve of the electrohydrostatic actuator of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The use herein of the term “axial” and variations thereof refers to a direction that extends generally along an axis of symmetry, a central axis, or an elongate direction of a particular component or system. For example, axially extending features of a component may be features that extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference or periphery of an object, around an axis of symmetry, around a central axis, or around an elongate direction of a particular component or system.

Conventional distributive hydraulic systems typically use inefficient pumps, restrictive hoses and fittings, and distribution control valves that meter axis movements or functions with greater inherent energy losses. These losses in fluid conveyance and directional control valve restrictions are present in distributive hydraulic systems independent of architecture type: open center or load sense (LS) control strategies. Accordingly, a need exists in the market for high-powered and high-efficiency hydraulic system solutions for use in hybrid or battery-electric vehicles that are both durable in extreme environments and efficient in operation. The systems and methods of the present disclosure provide an electrohydrostatic actuator with an integrated pump (e.g., a pump in cylinder (PiC) concept) that satisfies that market need and significantly improves on the efficiency of conventional PTO-driven or electric-over-hydraulic approaches.

According to an exemplary embodiment, the electrohydrostatic actuator includes an electric motor, a hydraulic pump, an accumulator, and a piston/rod combination that are integrated into a cylinder or body so that the electrohydrostatic actuator is a single, self-contained component. In this way, for example, the electrohydrostatic actuator is able to be mounted/installed on a vocational vehicle, an off-highway vehicle, or a military vehicle as a single unit and only requires an electrical connection to power the electrohydrostatic actuator and enable operation of the electrohydrostatic actuator (e.g., provide selective actuation of a function on a vocational vehicle, an off-highway vehicle, or a military vehicle). In general, the electrohydrostatic actuator eliminates or reduces the efficiency losses associated with conventional hydraulic systems with the implementation of individualized function architecture and an electric interface that provides the power needed to drive the internal hydraulics for specific machine functions for vocational vehicles, an off-highway vehicles, or a military vehicles.

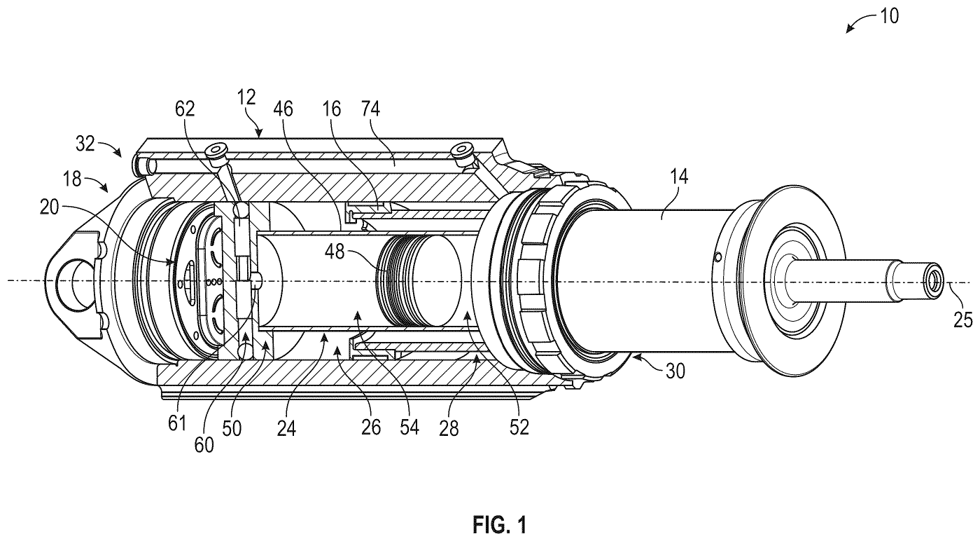

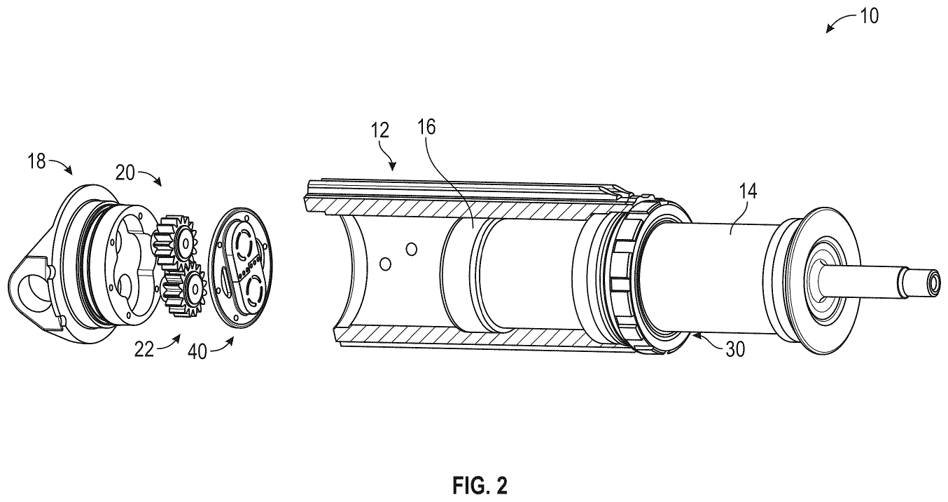

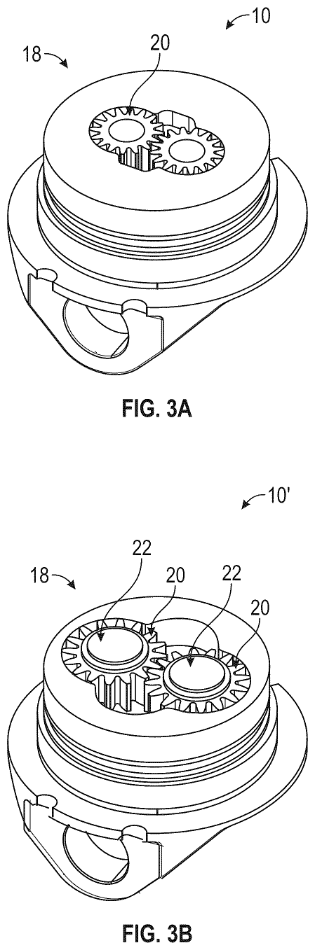

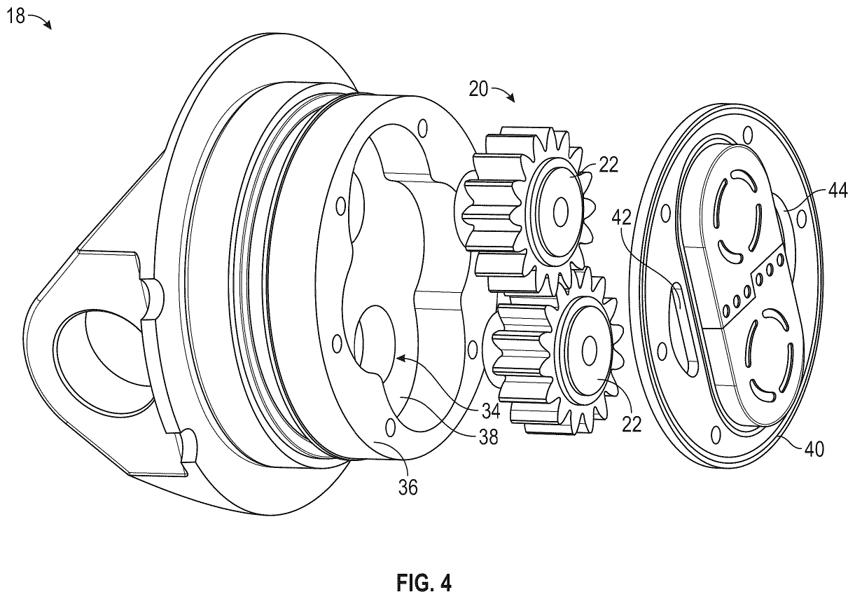

FIGS. 1-10 show an actuator system or electrohydrostatic actuator 10, according to an exemplary embodiment. With specific reference to FIGS. 1 and 2, the electrohydrostatic actuator 10 includes a cylinder 12, a rod 14, a piston 16, a base 18, a pump 20, an electric motor 22, and an accumulator 24. The cylinder 12 defines a generally cylindrical shape that extends along a central axis 25 and that includes a hollow cavity extending axially through the cylinder 12. In general, the cylinder 12 defines an outer body that the remaining components of the electrohydrostatic actuator 10 are coupled to and/or housed within. In this way, for example, the electrohydrostatic actuator 10 defines a single component (e.g., all the components of the electrohydrostatic actuator 10 are mounted/installed as a single unit).

The piston 16 is slidably received within the cylinder 12 and is coupled to the rod 14. The piston 16 divides a portion of the internal volume within the cylinder 12 (e.g., the volume arranged radially outwardly from the accumulator 24) into a piston chamber 26 (e.g., a volume filled with fluid (e.g., hydraulic fluid) that acts on a first side of the piston 16, or a side opposite to the rod 14) and a rod chamber 28 (e.g., a volume filled with fluid (e.g., hydraulic fluid) that acts on a second side of the piston 16, or a side that is coupled to the rod 14).

The rod 14 is at least partially received within the cylinder 12 and extends outwardly from a first end 30 of the cylinder 12. The base 18 is coupled to a second end 32 of the cylinder 12 (e.g., an end that is axially opposite to the first end 30, or an end opposite to the end that the rod 14 extends through). The pump 20 and the electric motor 22 are both housed or mounted within the base 18 and enclosed within the cylinder 12. Specifically, the base 18 includes a recessed cavity 34 that extends axially into a mounting surface 36 (e.g., a surface arranged within the cylinder 12). The pump 20 and the electric motor 22 are at least partially received within the recessed cavity 34 so that a recessed surface 38 of the recessed cavity 34 forms a back plate for the pump 20 (see, e.g., FIGS. 2-4). In some embodiments, the pump 20 is in the form of a gear pump (e.g., a bi-directional, bent axis, high speed synchronized gear pump) with two gears that are driven (rotated) in opposing directions in a synchronized manner. In these embodiments, the electric motor 22 may includes two electric motors that are arranged within the gears of the pump 20 (see, e.g. FIGS. 2-4). In some embodiments, the electric motor(s) 22 is a brushless electric motor.

As shown in FIGS. 1-4, a front plate 40 is coupled to the base 18 and at least partially encloses the pump 20 and the electric motor 22 between the front plate 40 and the base 18. In other words, the front plate 40 is arranged axially between the base 18 (e.g., the mounting surface 36) and the accumulator valve plate 50. The front plate 40 defines a first port 42 that is in fluid communication with a first side of the pump 20 and the second port 44 that is in fluid communication with a second side of the pump 20. In general, the first port 42 and the second port 44 act as the inlet/outlet of the pump 20, depending on the rotational direction of the pump 20 (e.g., of the pump gears). If the pump 20 is driven to rotate in a first configuration, the first port 42 acts as the outlet and fluid is supplied to the pump 20 through the second port 44 (the inlet) and furnished to the first port 42 (the outlet) at increased pressure. If the pump 20 is driven to rotate in a second configuration opposite to the first configuration, the second port 44 acts as the outlet and fluid is supplied to the pump 20 through the first port 42 (the inlet) and furnished to the second port 44 (the outlet) at increased pressure.

In general, the accumulator 24 is in fluid communication with the pump 20 so that the accumulator 24 is fluidly connected to whichever side of the pump 20 (e.g., either the first port 42 or the second port 44) is acting as the inlet, which aids in reducing or preventing cavitation. The accumulator 24 includes an accumulator cylinder 46 and an accumulator piston 48 slidably arranged within the accumulator cylinder 46. The accumulator cylinder 46 is arranged within the cylinder 12 and extends axially within the internal cavity of the cylinder 12. Specifically, the accumulator cylinder 46 is arranged radially inwardly of the rod 14 and the piston 16, and is received within at least a portion of the rod 14. In other words, the rod 14 is arranged radially between the accumulator cylinder 46 and the cylinder 12. The accumulator cylinder 46 may be fixed within the cylinder 12 and the rod 14 may telescope (e.g., extend/retract) relative to the accumulator cylinder 46. The accumulator cylinder 46 extends axially from an accumulator valve plate 50 to a free end that generally aligns axially (e.g., extends to a similar location or plane) with the first end 30 of the cylinder 12.

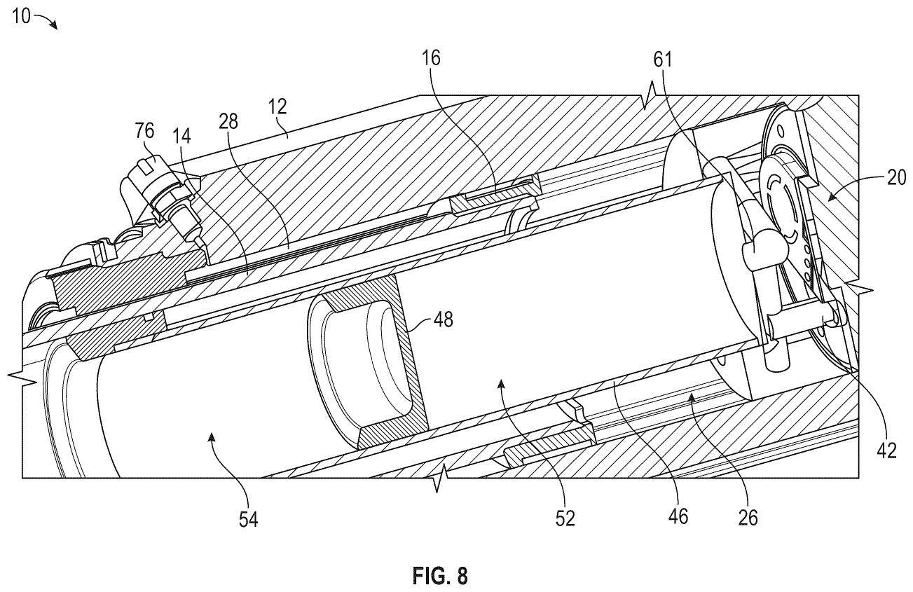

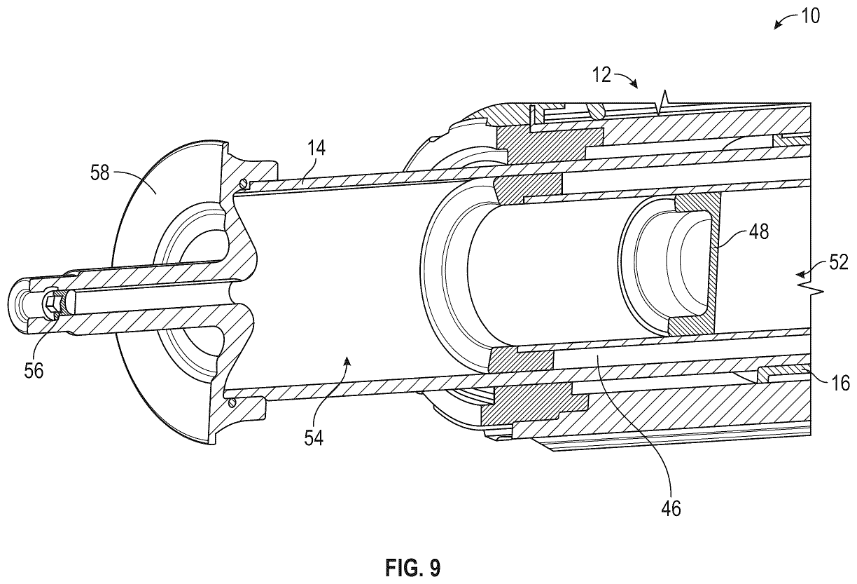

The accumulator piston 48 divides an internal volume of the accumulator cylinder 46 into a charge chamber 52 and a pump chamber 54. The charge chamber 52 is pressurized with a compressed gas (e.g., nitrogen) through a charge port 56 formed in a charge plate 58 (see, e.g., FIG. 9) that is coupled to a distal end of the rod 14 (e.g., an end that is external to the cylinder 12). In some embodiments, the charge chamber 52 is formed by both a portion of the internal volume defined within the accumulator cylinder 46 and a portion of the internal volume defined by within the rod 14 (see, e.g., FIGS. 8-9) that are arranged on the charge side of the accumulator piston 48. The pump chamber 54 is filled with fluid (e.g., hydraulic fluid) that is supplied to and/or placed in fluid communication with whichever side of the pump 20 (e.g., either the first port 42 or the second port 44) is acting as the inlet (e.g., a low-pressure port or side of the pump 20, whichever of the first port 42 and the second port 44 is at the lower pressure).

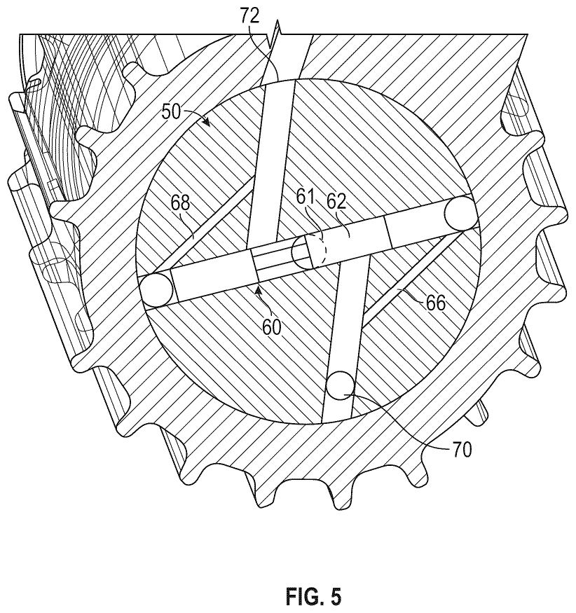

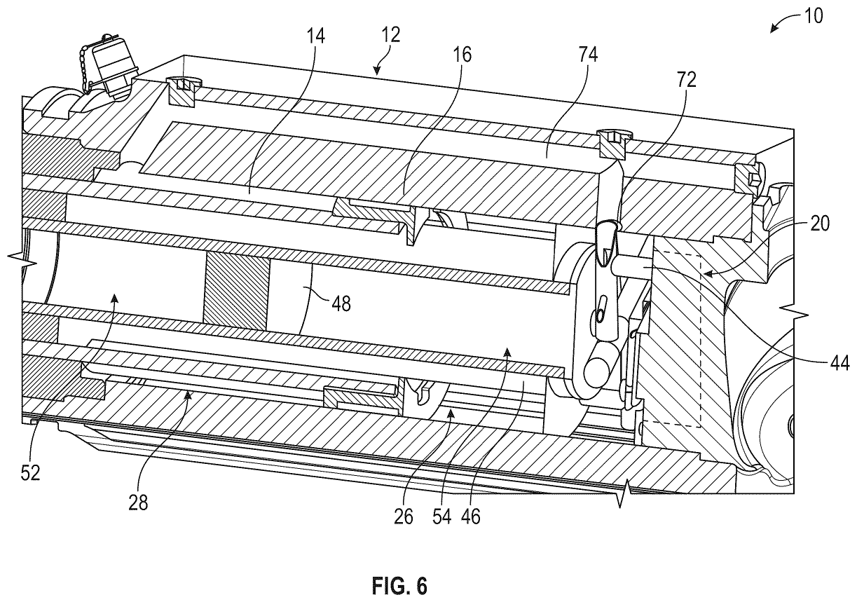

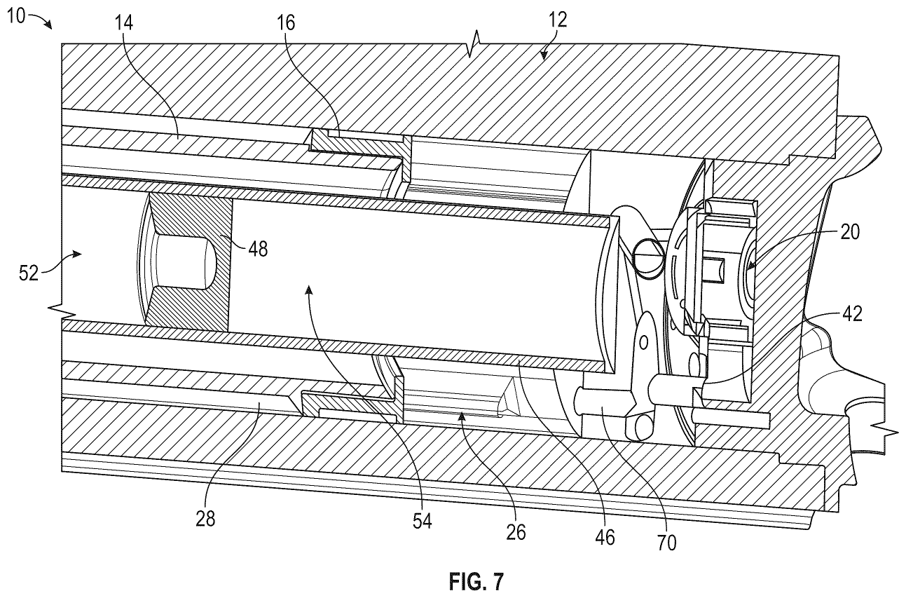

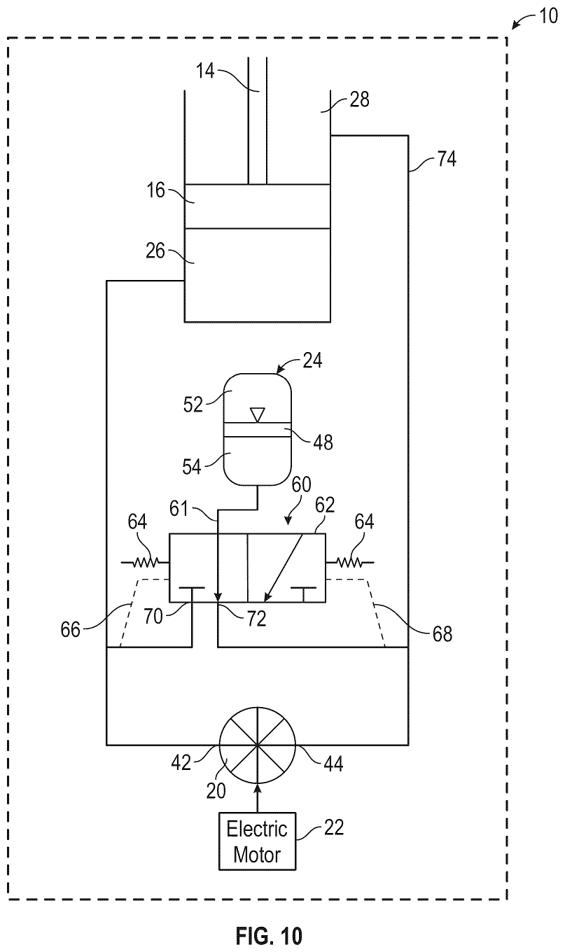

An accumulator valve 60 is arranged within the accumulator valve plate 50. The accumulator valve 60 is arranged axially between the pump 20 and the accumulator 24. In general, the accumulator valve 60 is configured to place whichever side of the pump 20 is acting as the inlet (e.g., either the first port 42 or the second port 44) in fluid communication with the pump chamber 54 through an accumulator port 61 arranged in the accumulator valve plate 50 (see, e.g., FIGS. 8 and 10), and thereby allow the pressurized gas within the charge chamber 52 to apply a force on the fluid (e.g., hydraulic fluid) in the pump chamber 54, which acts on the inlet (e.g., low-pressure side) of the pump 20. As shown in FIG. 5, the accumulator valve 60 includes a spool 62 that is slidably received within a channel or passageway formed in the accumulator valve plate 50. In some embodiments, the spool 62 is biased by springs 64 arranged on both ends thereof (see, e.g., FIG. 10). A piston pilot line 66 is in fluid communication with a first end of the spool 62 and a rod pilot line 68 is in fluid communication with a second opposing end of the spool 62 (see, e.g., FIGS. 5 and 10). The piston pilot line 66 is in fluid communication with a piston port 70 formed in the accumulator valve plate 50, and the rod pilot line 68 is in fluid communication with a rod port 72 formed in the accumulator valve plate 50. In other words, the piston pilot line 66 provides fluid communication between the first end of the spool 62 and the piston port 70, and the rod pilot line 68 provides fluid communication between the second end of the spool 62 and the rod port 72. The piston port 70 is in fluid communication with the first port 42 of the pump 20 (see, e.g., FIGS. 7 and 10). Accordingly, the fluid communication between the first end of the spool 62 and the piston port 70 provided by the piston pilot line 66 communicates the pressure from the first port 42 to the first end of the spool 62. The rod port 72 is in fluid communication with the second port 44 of the pump 20 (see, e.g., FIGS. 6 and 10). Accordingly, the fluid communication between the second end of the spool 62 and the rod port 72 provided by the rod pilot line 68 communicates pressure from the second port 44 to the second end of the spool 62.

The piston port 70 is in fluid communication with the piston chamber 26 (see, e.g., FIGS. 7 and 10). The rod port 72 is in fluid communication with the rod chamber 28 through a rod line, passageway, or conduit 74 formed in the cylinder 12 (see, e.g., FIGS. 6 and 10). Specifically, the rod conduit 74 is formed within an outer wall of the cylinder 12 and extends between the rod port 72 and the rod chamber 28.

With reference to FIGS. 1-10, during operation of the electrohydrostatic actuator 10, the pump 20 is configured to operate in a first configuration and a second configuration. In the first configuration, pressurized fluid (e.g., hydraulic fluid) is provided to the piston chamber 26 to move the piston 16 and the rod 14 coupled there to so that the rod 14 extends from the cylinder 12. In the second configuration, pressurize fluid (e.g., hydraulic fluid) is provided to the rod chamber 28 to move the piston 16 and the rod 14 so that the ro1 4 retracts into the cylinder 12. In some embodiments, in the first configuration, the pump 20 rotates in a first direction (e.g., the gears rotate in a first set of opposing directions) so that the first port 42 acts as the outlet (e.g., a high-pressure side/port) and the second port 44 acts as the inlet (e.g., low-pressure side/port). In this configuration, the high pressure in the first port 42 is communicated to the piston port 70 and, thereby, to the piston pilot line 66. The low pressure in the second port 44 is communicated to the rod port 72 and thereby to the rod pilot line 68. With low pressure in the rod pilot line 68 and high pressure in the piston pilot line 66, a pressure differential is generated on between ends of the spool 62 of the accumulator valve 60, and the pressure differential applies a force on the spool 62 to bias or actuate the spool 62 into a first position (e.g., the position shown in FIG. 10). With the spool 62 in the first position, fluid communication is provided between the accumulator port 61 and the second port 44 through the rod port 72, and fluid communication is prevented between the accumulator port 61 and both the piston port 70 and the first port 42.

With the pump 20 operating in the first configuration, fluid (e.g., hydraulic fluid) is drawn from the rod chamber 28 and/or the pump chamber 54 of the accumulator 24 and provided by the pump 20, at increased pressure, to the piston chamber 26, which results in the rod 14 extending from the cylinder 12. If it is desired to retract the rod 14 into the cylinder 12, the pump 20 may be operated in the second configuration, where the pump 20 rotates in a second direction (e.g., the gears rotate in a second set of opposing directions and is opposite to the first set of opposing directions) so that the second port 44 acts as the outlet (e.g., high-pressure side/port) and the first port 42 acts as the inlet (e.g., low-pressure side/port). In this configuration, the high pressure in the second port 44 is communicated to the rod port 72 and, thereby, to the rod pilot line 68. The low pressure in the first port 42 is communicated to the piston port 70 and thereby to the piston pilot line 66. With low pressure in the piston pilot line 66 and high pressure in the rod pilot line 68, a pressure differential is generated between opposing ends of the spool 62 of the accumulator valve 60, and the pressure differential applies a force on the spool 62 to bias or actuate the spool 62 into a second position (e.g., moved to the left from the perspective of FIG. 10). With the spool 62 in the second position, fluid communication is provided between the accumulator port 61 and the first port 42 through the piston port 70, and fluid communication is prevented between the accumulator port 61 and both of the rod port 72 and the second port 44.

With the pump 20 operating in the second configuration, fluid (e.g., hydraulic fluid) is drawn from the piston chamber 26 and/or the pump chamber 54 of the accumulator 24 and provided by the pump 20, at increased pressure, to the rod chamber 28, which results in the rod 14 retracting into the cylinder 12.

In both operational configurations of the pump 20, the accumulator valve 60 supplies fluid communication between the pump chamber 54 of the accumulator 24 and the inlet of the pump 20 (i.e., the first port 42 or the second port 44), which aids in reducing or preventing pump cavitation during operation. In other words, the piston pilot line 66 and the rod pilot line 68 sense the pressure generated at the first port 42 and the second port 44, and communicate these sensed pressures to opposing ends of the spool 62, which generates a pressure differential on the spool 62. The pressure differential on the spool 62 moves the spool 62 so that the accumulator port 61 is placed in fluid communication with a low-pressure port of the pump 20.

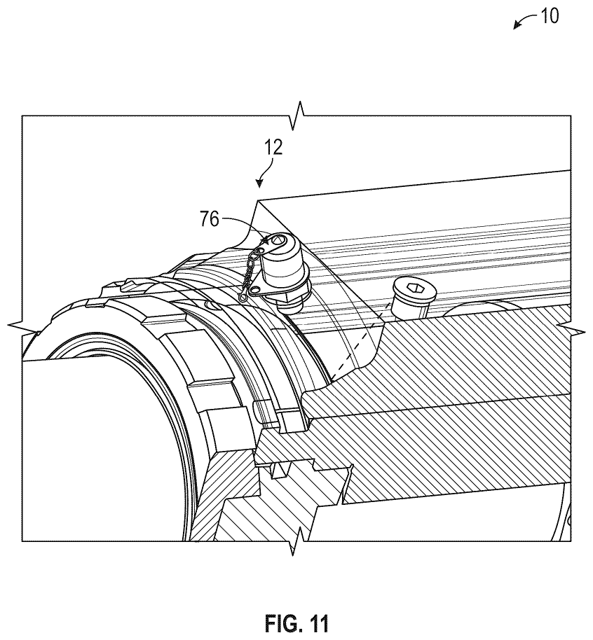

In some embodiments, the electrohydrostatic actuator 10 defines a closed circuit or system that does not require excess fluid (e.g., hydraulic fluid) from a reservoir or tank. In other words, the fluid components (e.g., the pump 20, the accumulator 24, the accumulator valve 60, etc.) of the electrohydrostatic actuator 10 operate within a closed fluid circuit that does not require excess fluid from a reservoir or tank. With all the components of the electrohydrostatic actuator 10 being coupled to or housed within the cylinder 12, the electrohydrostatic actuator 10 provides a single component that may be mounted to or installed on a vocational vehicle, an off-highway vehicle, or a military vehicle as a single unit and only requires an electrical connection to power and facilitate extension/retraction of the rod 14. In some embodiments, the closed system defined by the electrohydrostatic actuator 10 is charged with fluid (e.g., hydraulic fluid) via a charge valve 76 that is mounted on and coupled to an exterior surface of the cylinder 12 (see, e.g., FIGS. 8 and 11).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the electrohydrostatic actuator 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An actuator comprising:
a cylinder;
a piston slidably received within the cylinder;
a rod coupled to the piston and at least partially extending outwardly from the cylinder;
a base coupled to the cylinder;
a pump at least partially received within the base and including an inlet port;
an electric motor configured to drive the pump and at least partially received within the base;
an accumulator including an accumulator cylinder that is enclosed within the cylinder and an accumulator piston slidably received within the accumulator cylinder; and
an accumulator valve enclosed within the cylinder, wherein the accumulator valve is configured to selectively provide fluid communication between the accumulator and the inlet port.

2. The actuator of claim 1, wherein the rod is arranged radially between the accumulator cylinder and the cylinder.

3. The actuator of claim 1, wherein the accumulator valve is arranged axially between the pump and the accumulator.

4. The actuator of claim 1, wherein the accumulator valve is arranged within an accumulator valve plate, wherein the accumulator valve plate includes a spool slidably received within the accumulator valve plate, a piston pilot line, a rod pilot line, a piston port, a rod port, and an accumulator port.

5. The actuator of claim 4, wherein the piston pilot line provides fluid communication between a first end of the spool and the piston port, and the rod pilot line provides fluid communication between a second end of the spool and the rod port.

6. The actuator of claim 4, wherein the accumulator piston divides an internal volume of the accumulator cylinder into a charge chamber and a pump chamber, and wherein the accumulator port is in fluid communication with the pump chamber.

7. The actuator of claim 6, wherein the piston divides a portion of the internal volume of the cylinder into a piston chamber and a rod chamber, and wherein the piston port is in fluid communication with the piston chamber and the rod port is in fluid communication with the rod chamber.

8. The actuator of claim 7, wherein the portion of the internal volume of the cylinder is arranged radially outwardly from the accumulator cylinder.

9. The actuator of claim 7, wherein a rod conduit provides fluid communication between the rod port and the rod chamber.

10. The actuator of claim 9, wherein the rod conduit is formed within an outer wall of the cylinder.

11. An actuator comprising:
a cylinder;
a piston slidably received within the cylinder, wherein the piston divides a portion of an internal volume of the cylinder into a piston chamber and a rod chamber;
a rod coupled to the piston and at least partially extending outwardly from the cylinder;
a base coupled to the cylinder;
a pump at least partially received within the base and including a first port and a second port;
an electric motor configured to drive the pump and enclosed within the cylinder;
an accumulator enclosed within the cylinder; and
an accumulator valve enclosed within the cylinder,
wherein the pump is configured to operate in a first configuration and a second configuration,
in the first configuration, the pump is configured to supply pressurized fluid to the piston chamber so that the rod extends from the cylinder, and
in the second configuration, the pump is configured to supply pressurized fluid to the rod chamber so that the rod retracts into the cylinder, wherein when the pump is in the first configuration and the second configuration, the accumulator valve is configured to selectively provide fluid communication between the accumulator and whichever of the first port and the second port is at a lower pressure.

12. The actuator of claim 11, wherein the rod is arranged radially between the accumulator and the cylinder.

13. The actuator of claim 11, wherein the accumulator valve is arranged axially between the pump and the accumulator.

14. The actuator of claim 11, wherein the accumulator valve is arranged within an accumulator valve plate, wherein the accumulator valve plate includes a spool slidably received within the accumulator valve plate, a piston pilot line, a rod pilot line, a piston port, a rod port, and an accumulator port.

15. The actuator of claim 14, wherein the piston pilot line communicates a pressure at the first port to a first end of the spool, and the rod pilot line communicates a pressure at the second port to a second end of the spool.

16. The actuator of claim 14, wherein the accumulator port is in fluid communication with the accumulator.

17. The actuator of claim 16, wherein the piston port is in fluid communication with the piston chamber and the rod port is in fluid communication with the rod chamber.

18. The actuator of claim 11, wherein the portion of the internal volume of the cylinder is arranged radially outwardly from the accumulator.

19. An actuator comprising:
an outer body;
a piston slidably received within the outer body;
a rod coupled to the piston and at least partially extending outwardly from the outer body;
a base coupled to a first end of the outer body, wherein the rod extends outwardly from a second end of the outer body;
a pump at least partially received within the base;
an electric motor configured to drive the pump and at least partially received within the base;
an accumulator including an accumulator cylinder and an accumulator piston slidably received within the accumulator cylinder; and
an accumulator valve arranged axially between the pump and the accumulator, wherein each of the piston, the rod, the base, the pump, the electric motor, the accumulator, and the accumulator valve is coupled to or housed within the outer body, and wherein the pump, the accumulator, and the accumulator valve operate in a closed fluid circuit.

20. The actuator of claim 19, wherein the pump includes a first port and a second port and is configured to operate in a first configuration and a second configuration,
in the first configuration, the pump is configured to supply pressurized fluid to a piston chamber formed within the outer body so that the rod extends from the outer body, and
in the second configuration, the pump is configured to supply pressurized fluid to a rod chamber formed within the outer body so that the rod retracts into the outer body, wherein when the pump is in the first configuration and the second configuration, the accumulator valve is configured to selectively provide fluid communication between the accumulator and whichever of the first port and the second port is at a lower pressure.
